(19) United States
(12) Patent Application Publication
(10) Pub. No.: US 2005/0014907 A1
(43) Pub. Date: Jan. 20, 2005

(54) Process for the solventless preparation of ethylenically unsaturated polyurethanes

(76) Inventors: Jan Weikard, Odenthal (DE); Thomas Facke, Bridgeville, PA (US); Josef Sanders, Leverkusen (DE); Christian Wamprecht, Neuss (DE)

Correspondence Address: BAYER MATERIAL SCIENCE LLC, 100 BAYER ROAD, PITTSBURGH, PA, 15205, US

(21) Appl. No.: 10/876,956

(22) Filed: Jun. 25, 2004

(30) Foreign Application Priority Data
Jul. 3, 2003 (DE) 10330029.5
Jul. 14, 2003 (DE) 10331672.8

(51) Int. Cl. C08G 71/04

(52) U.S. Cl. 525/453

(57) ABSTRACT

A process for the solventless preparation of ethylenically unsaturated polyurethanes. The process includes preparing a prepolymer from an isocyanate-containing component A) and an isocyanate-reactive component B) in a batch reaction, and reacting the prepolymer with a further component C) in a second, continuous reaction to provide a polyurethane, where at least one of the components A, B and C have ethylenically unsaturated groups.

### CROSS REFERENCE TO RELATED PATENT APPLICATION

The present patent application claims the right of priority under 35 U.S.C. §119 (a)-(d) of German Patent Application No.103 30 029.5, filed Jul. 3, 2003.

### BACKGROUND OF THE INVENTION

1. Field of the Invention

The invention relates to a process for the solventless preparation of ethylenically unsaturated polyurethanes.

2. Description of the Prior Art

Ethylenically unsaturated polyurethanes are used for example as raw materials for the production of pulverulent coating agents which cure under the influence of actinic radiation.

DE-A 19 947 522 discloses polymerizable polyurethanes based on linear diisocyanates, and their use. These compounds are prepared in three steps. In a first step an olefinically unsaturated compound having an isocyanate-reactive group is reacted with excess diisocyanate. The excess diisocyanate is then removed by distillation and the product is reacted with a further difunctional isocyanate-reactive compound. This reaction takes place in a solvent. This procedure has the disadvantage firstly that, in the second step, a comparatively high-boiling diisocyanate has to be distilled out of a mixture with a thermally labile, olefinically unsaturated compound, and secondly that the end product is obtained in a solvent which ultimately has to be removed at high cost. Preparation in a continuous process is not mentioned and nor can the process described be carried out continuously.

EP-A 1 078 943 describes the solventless preparation of polyurethanes having (meth)acryloyl groups by the reaction of polyisocyanates with hydroxyl compounds, some of which have (meth)acryloyl groups:
A) A monoisocyanate or diisocyanate having 4 to 20 carbon atoms and
B) a diisocyanate and/or polyisocyanate component containing at least one diisocyanate or polyisocyanate
   are reacted with
C) a monohydroxyalkyl (meth)acrylate having 2 to 12 carbon atoms in the alkyl chain,
D) an alcohol component having (meth)acryloyl groups and consisting of at least one alcohol having (meth)acryloyl groups, and
E) a compound free of (meth)acryloyl groups and difunctionally or polyfunctionally reactive towards isocyanates,
   the amount of C) (mol of OH groups) corresponding to the amount of A) (mol of NCO groups), the sum of the amounts of D) (mol of isocyanate-reactive groups) and E) (mol of isocyanate-reactive groups) corresponding to the amount of B) (mol of NCO groups), and the proportion of A) and C) together being 10 to 95%, based on the total weight of oligourethanes and polyurethanes having (meth)acryloyl groups.

This reaction takes place in one or more steps in a batch process. The possibility of also carrying out the reaction in a one-stage continuous process is likewise disclosed. WO 03/044111 also discloses basically the same possibilities. A disadvantage of the one-stage continuous process is the fact that the polyurethane cannot be synthesized stepwise and hence in a controlled manner. Both process variants have the disadvantage of the unavoidable presence of low-molecular products from the reaction of components A and C with one another. Such low-molecular products tend to crystallize, which is undesirable in surface coatings. Although it is possible to prevent this undesirable effect by the appropriate choice of component C, e.g. by using mixtures of different monohydroxyalkyl (meth)acrylates, i.e. those with different, optionally branched alkyl chains having only a low tendency to crystallize, this is associated with an increased cost and therefore makes the resulting products more expensive.

The object of the present invention was therefore to provide a process which allows both the solventless preparation of ethylenically unsaturated polyurethanes and a controlled multistage polymer synthesis avoiding the disadvantages described above, especially the presence of low-molecular constituents that tend to crystallize.

### SUMMARY OF THE INVENTION

The present invention is directed to a process for the solventless preparation of ethylenically unsaturated polyurethanes. The process includes preparing a prepolymer from an isocyanate-containing component A) and an isocyanate-reactive component B) in a batch reaction, and reacting the prepolymer with a further component C) in a second, continuous reaction to provide a polyurethane, where at least one of the components A, B and C have ethylenically unsaturated groups.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

The present invention provides a process for the solventless preparation of ethylenically unsaturated polyurethanes, characterized in that a prepolymer is first prepared from an isocyanate-containing component A) and an isocyanate-reactive component B) in a batch reaction, and then reacted with a component C) in a second, continuous reaction to give the polyurethane, at least one of the components A, B and C having ethylenically unsaturated groups.

In terms of the invention, prepolymers are monomeric, oligomeric or polymeric compounds, or mixtures thereof, which are obtained by the formation of at least one urethane, thiourethane or urea group and furthermore have suitable chemical functional groups, e.g. isocyanate or hydroxyl groups, which allow further polymer synthesis by the addition of monomers having chemically corresponding functional groups in the sense of an addition reaction.

Continuous reactions in terms of the invention are those in which the introduction of the educts into the reactor and the discharge of the products from the reactor take place simultaneously but at separate locations, whereas in a batch reaction the reaction steps comprising introduction of the educts, chemical reaction and discharge of the products take place consecutively.

The prepolymer is prepared by reacting the isocyanate-containing component A) with the isocyanate-reactive component B).

Component A) contains at least one organic mono-, di- or polyisocyanate which can be aliphatic, araliphatic or aromatic: 3-methacryloylpropyl isocyanate, cyclohexyl isocyanate, n-butyl isocyanate, phenyl isocyanate, toluyl isocyanate, 1,4-tetramethylene diisocyanate, 1,6-hexamethylene diisocyanate (HDI), 1,8-octamethylene diisocyanate, 1,11-undecamethylene diisocyanate, 1,12-dodecamethylene diisocyanate, 2,2,4- or 2,4,4-trimethyl-1,6-hexamethylene diisocyanate (TMDI), 1,3- and 1,4-cyclohexane diisocyanate, 1-isocyanato-3-isocyanatomethyl-3,5,5-trimethylcyclohexane (IPDI), 1-isocyanato-1-methyl-4(3)-isocyanatomethylcyclohexane (IMCI), 1,4-phenylene diisocyanate, 1,5-naphthylene diisocyanate, 1-isocyanato-2-isocyanatomethylcyclopentane, 4,4′- and/or 2,4′-diisocyanatodicyclohexylmethane (H12-MDI), xylylene diisocyanate (XDI), bis(4-isocyanato-3-methylcyclohexyl)methane, 1,3- and/or 1,4-hexahydroxylylene diisocyanate (H6-XDI), α,α,α′,α′-tetramethyl-1,3- and/or −1,4-xylylene diisocyanate (TMXDI), 2,4- and/or 2,6-hexahydrotoluylene diisocyanate (H6-TDI), 2,4- and/or 2,6-toluene diisocyanate (TDI), 4,4′- and/or 2,4′-diphenylmethane diisocyanate (MDI) or derivatives thereof with urethane, isocyanurate, allophanate, biuret, uretdione, carbodiimide, oxadiazinetrione and/or iminooxadiazinedione structural units, provided they have at least one free NCO group, and mixtures thereof. IPDI, TDI, H12-MDI, H6-XDI and the uretdiones of IPDI and H12-MDI, and mixtures thereof, are preferred. IPDI is particularly preferred.

Component B) contains at least one isocyanate-reactive compound, such compounds containing e.g. hydroxyl, thiol and primary and/or secondary amino groups. Alcohols are preferred, those having ethylenically unsaturated groups are particularly preferred and, of these, those with a hydroxyl functionality of 1 are very particularly preferred.

Examples of suitable alcohols are monofunctional aliphatic, araliphatic and aromatic alcohols such as methanol, ethanol, n-propanol, isopropanol, butanol, hexanol, fatty alcohols, phenols, etc. and especially hydroxyalkyl (meth)acrylates having 2 to 12 carbon atoms in the alkyl chain, preferably 2 to 4 carbon atoms in the hydroxyalkyl radical, such as hydroxyethyl (meth)acrylate, 2- and 3-hydroxypropyl (meth)acrylate and 2-, 3- and 4-hydroxybutyl (meth)acrylate, as well as 1,4-cyclohexanedimethanol monoacrylate, OH-functional vinyl ethers, e.g. hydroxybutyl vinyl ether, and mixtures thereof. It is also possible to use alcohols from the reaction of epoxy-functional (meth)acrylic acid esters with (meth)acrylic acid. Thus the reaction of glycidyl methacrylate with acrylic acid gives a mixed glycerol acrylic acid/methacrylic acid ester, which can also advantageously be used. Hydroxyethyl acrylate and the isomeric hydroxypropyl acrylates are preferred.

Examples of suitable aliphatic, araliphatic and aromatic diols or polyols are 1,2-ethanediol, 1,2- and 1,3-propanediol, the isomeric butanediols, neopentyl glycol, 1,6-hexanediol, 2-methyl-1,3-propanediol, 2,2,4-trimethyl-1,3-pentanediol, 2-n-butyl-2-ethyl-1,3-propanediol, glycerol monoalkanoates (e.g. the glycerol monostearates), dimeric fatty alcohols, diethylene glycol, triethylene glycol, tetraethylene glycol, 1,4-dimethylolcyclohexane, dodecanediol, bisphenol A, hydrogenated bisphenol A, 1,3-hexanediol, 1,3-octanediol, 1,3-decanediol, 3-methyl-1,5-pentanediol, 3,3-dimethyl-1,2-butanediol, 2-methyl-1,3-pentanediol, 2-methyl-2,4-pentanediol, 3-hydroxymethyl-4-heptanol, 2-hydroxymethyl-2,3-dimethyl-1-pentanol, glycerol, trimethylolethane, trimethylolpropane, trimeric fatty alcohols, the isomeric hexanetriols, sorbitol, pentaerythritol, ditrimethylol-propane, dipentaerythritol, diglycerol and tricyclodecanediol (TCD). 1,2-Ethanediol, 1,2- and 1,3-propanediol, the isomeric butanediols, neopentyl glycol, 1,6-hexanediol, 2-ethyl-1,3-hexanediol, perhydrobisphenol and 4,8-bis(hydroxy-methyl)tricyclo[5.2.0(2.6)]decane (TCD alcohol) are preferred. 1,2-Ethanediol, 1,2-propanediol and 1,4-butanediol are particularly preferred.

It is also possible to use OH-functional esters with a mean Mw of <2000, preferably of <500, which are obtained by reacting the above-mentioned polyols with ε-caprolactone. Unsaturated esters which, in addition to said alcohols, consist of unsaturated acids or alcohols such as maleic acid (anhydride), fumaric acid, itaconic acid, citraconic acid (anhydride), aconitic acid, tetrahydrophthalic acid (anhydride), 3,6-endomethylene-1,2,3,6-tetrahydrophthalic acid (anhydride) and butenediols, are also used.

Alcohols and amines having (meth)acryloyl groups, or reaction products consisting substantially thereof, which are obtained by the condensation of n-hydric alcohols or amines or amino alcohols with (meth)acrylic acid, are also suitable, it further being possible to use mixtures as the alcohols, amines or amino alcohols. These compounds or product mixtures include e.g. the reaction products of glycerol, trimethylolpropane and/or pentaerythritol or of low-molecular alkoxylation products of such alcohols, for example ethoxylated or propoxylated trimethylolpropane, with (meth)acrylic acid.

In combination with an alcohol it is also possible to use the following amines, urea groups being formed proportionately: ethanolamine, N-methylethanolamine, N-ethylethanolamine, 2-amino-1-propanol, tetramethylxylylenediamine, ethylene-diamine, 1,6-hexamethylenediamine, isophoronediamine (IPDA), 4,4′- and/or 2,4′-diaminodicyclohexylmethane and 4,4′- and/or 2,4′-diamino-3,3′-dimethyldicyclohexylmethane.

The reaction of components A) and B) is carried out batchwise, for example in a stirred tank with heating/cooling, temperature measurement and metering devices. The reaction itself takes place under conditions familiar to those skilled in the art from urethane chemistry. Advantageously, one component is placed in the tank at 20 to 120° C., preferably 30 to 60° C. The second component is then metered in, with stirring, the temperature being influenced by the heat of reaction and if appropriate by melting or dissolution processes and being controllable by heating or cooling. The course of the reaction is monitored using the following possible parameters: the isocyanate content, the hydroxyl content, the viscosity and/or spectroscopic parameters obtainable e.g. by infrared or near infrared spectroscopy.

The measurements can be made on samples taken from the reaction mixture or by means of appropriate measuring devices in the reactor.

The addition reaction yielding the urethane can be accelerated in a manner known per se by means of suitable catalysts, for example tin octoate, dibutyltin dilaurate or tertiary amines such as dimethylbenzylamine. It is known that the reaction of diisocyanates having variously reactive isocyanate groups, e.g. IPDI, with alcohols can be carried out with increased selectivity by means of suitable catalysts, e.g. dibutyltin dilaurate, at temperatures below 100° C., preferably below 65° C.

If components A) or B) contain ethylenically unsaturated constituents, it is advantageous to protect against premature and undesirable free radical polymerization by the addition of suitable inhibitors or antioxidants, for example phenols and/or hydroquinones and/or stable N-oxyl radicals and/or phenothiazine or other free radical scavengers, in amounts of 0.0005 to 0.3 wt. % in each case, based on the total weight of A) and B). These auxiliary substances can be added before, simultaneously with and/or after the reaction.

The equivalent ratio of A) to B) is preferably chosen so that either the isocyanate groups or the isocyanate-reactive groups are present in excess. Advantageously, therefore, the prepolymer has NCO contents greater than 3.0 wt. %, preferably greater than 5.0 wt. %, in the case of an excess of isocyanate, or hydroxyl contents greater than 3.0 wt. %, preferably 5.0 wt. %, in the case of an excess of hydroxyl groups. Prepolymers with an excess of isocyanate and an NCO content greater than 10.0 wt. % are particularly preferred.

Preferred prepolymers are those having a dynamic viscosity below 10,000 mPa·s at 23° C., which can therefore still be conveyed with conventional pumps in the temperature range from 20 to 80° C. Particularly preferred prepolymers are those having a dynamic viscosity below 1000 mPa·s at 60° C. The viscosity of the prepolymers is particularly dependent on their molecular weight and their urethane group density, so an increase in the excess of one component generally leads to a lowering of the viscosity of the prepolymer.

The preparation of the prepolymer is followed by the continuous reaction to give the polyurethane. It is unimportant here whether the prepolymer is reacted further immediately after preparation, or stored first, or possibly transported to another plant.

Component C) contains groups that are reactive with the prepolymer in the sense of a (poly)addition to give the urethane. The mean functionality of C) in terms of these groups is between 1.3 and 4, preferably between 1.8 and 2.4. The equivalent ratios are chosen so that the ratio of isocyanate-reactive groups to isocyanate groups is between 0.8 and 3.0, preferably between 0.9 and 3.0, particularly preferably between 0.9 and 2.5 and very particularly preferably between 0.95 and 2.20.

Particularly suitable constituents of component C) are either the compounds mentioned under A) or the compounds mentioned under B). The above-mentioned stabilizers and/or catalysts can also be added to the prepolymer or to component C).

The reactive diluents familiar to those skilled in the art from the chemistry of radiation-curing binders (cf. “Chemistry & Technology of UV & EB Formulations for Coatings, Inks & Paints”, vol. 2, P. K. T. Oldring (ed.), SITA Technology, London, England, pp 250-290, 1991) can also be added to the prepolymer or to component C). These reactive diluents do not normally possess any functional groups other than the radiation-curing functionalities. However, it is also possible to use compounds that additionally contain acid, epoxy, silyl, phosphine, phosphate, urea, isocyanurate, uretdione, biuret or other groups, especially if this achieves further advantageous effects, e.g. a better adhesion in the coating process.

Examples of reactive diluents are (meth)acrylic acid and its esters, vinyl (meth)acrylate, allyl (meth)acrylate, trimethylolpropane triallyl ether, glycerol tri-(meth)acrylate, trimethylolpropane tri(meth)acrylate, pentaerythritol tetra-(meth)acrylate and dipentaerythritol hexa(meth)acrylate, styrene, divinylbenzene, vinyltoluene, isobornyl (meth)acrylate, butoxyethyl (meth)acrylate, alkylene glycol di(meth)acrylates such as ethylene and propylene glycol di(meth)acrylates, polyalkylene glycol di(meth)acrylates such as polyethylene and polypropylene glycol di(meth)acrylates, di(meth)acrylates of simple diols, e.g. butanediol di(meth)acrylate, hexanediol di(meth)acrylate and cyclohexanedimethanol di(meth)acrylate, and dicyclopentyl (meth)acrylate. Preferred reactive diluents are hexanediol diacrylate, isobornyl methacrylate, isodecyl methacrylate, tricyclodecanedimethylol dimethacrylate, tripropylene glycol diacrylate, and the (meth)acrylated products of optionally ethoxylated or propoxylated diols or polyols such as trimethylolpropane, pentaerythritol, bisphenol A or cyclohexanedimethanol.

Mixtures of the above-mentioned compounds can also be used. Trimethylol-propane trimethacrylate and/or trimethylolpropane triacrylate are preferred. The proportion of reactive diluent is conventionally below 60 wt. %, based on the polyurethane, it being preferable to add less than 30 wt. % and particularly preferable to dispense with the use of reactive diluent altogether. Reactive diluents can of course also be replaced with solvents, although the use of solvents is less preferable because one of the advantages of the process is the possibility of dispensing with solvents.

The reaction of the prepolymer with component C) takes place continuously with the two constituents being conveyed through a reactor. Optionally, the material streams are first heated separately and then brought into contact with one another and intimately mixed together. The combined mixed material stream is then optionally heated or cooled and, after a certain reaction path, cooled and optionally formulated.

The prepolymer and component C), optionally with the addition of said stabilizers, catalysts or reactive diluents, are advantageously conveyed through the reactor from separate receivers. The material streams can be conveyed through the reactor under gravity, by gas pressure and/or advantageously by pumping, suitable pumps being any of the known types that are appropriate for conveying material of the relevant viscosity. If ethylenically unsaturated constituents are conveyed with pumps, it is advisable to use types of pump which subject the material to the least possible shear so as to prevent an unwanted polymerization of the ethylenically unsaturated constituents. Apart from gear pumps, reciprocating diaphragm pumps are particularly suitable. It is advantageous to pump the materials on the educt side of the reactor because the educts have a lower viscosity than the product. Advantageously, the amounts of the two educt material streams are controlled by suitable measuring and regulating devices which enable the ratio of the volumes or weights of the two material streams to be precisely adjusted. The two material streams are each advantageously heated by means of a heat exchanger to a temperature of 20 to 170° C., preferably of 40 to 120° C. and particularly preferably of 50 to 100° C. They are then mixed and conveyed through the reactor, which optionally contains other mixing elements. Examples of suitable reactors are static mixers, nozzles and extruders, it also being possible for several identical or different reactors of these types to be connected in series. Each of these reactors is advantageously provided with a cooling or heating device, e.g. a jacket through which a thermostatted heat transfer fluid is circulated. The use of several heating/cooling zones capable of independent thermostatting makes it possible e.g. to cool the flowing reaction mixture at the beginning of the reaction, i.e. shortly after mixing, and dissipate the heat of reaction evolved, and to heat the mixture towards the end of the reaction, i.e. shortly before discharge from the reactor, in order to maximize the conversion. The temperature of the cooling/heating agent can be between −25 and +250° C., preferably below 200° C. The temperature of the reaction mixture is influenced by the heat of reaction as well as by heating and/or cooling. If ethylenically unsaturated compounds are present, it is advisable not to exceed particular upper temperature limits, as otherwise the risk of an unwanted polymerization increases. For unsaturated acrylates the maximum reaction temperature should not exceed 250° C., preferably 200° C.

The higher the maximum reaction temperature, the shorter should be the residence time. The residence times of the reactants in the reaction zone are normally between 20 s and 30 min, preferably between 30 s and 10 min and particularly preferably between 1 and 6 min. The residence time can be controlled e.g. by the volume flows and the volume of the reaction zone. The course of the reaction is advantageously monitored by means of various measuring devices. Devices for measuring temperature, viscosity, thermal conductivity and/or refractive index in flowing media, and/or for measuring infrared and/or near infrared spectra, are particularly suitable for this purpose.

Towards the end of the reaction path, other desired additives conventionally used in coating technology can optionally be introduced and mixed in. Preferably, however, the additives will already have been incorporated into one of the reactants prior to the actual reaction. Such additives are photoinitiators, thermal initiators, inhibitors, light stabilizers such as UV absorbers and sterically hindered amines (HALS), and also antioxidants, fillers and coating aids, e.g. antisettling agents, degassing agents and/or wetting agents, flow control agents, reactive diluents, plasticizers, catalysts, and pigments, dyestuffs and/or flatting agents. The use of light stabilizers and the different types are described e.g. in A. Valet, Lichtschutzmittel für Lacke, Vincentz Verlag, Hannover, 1996.

The product obtained continuously at the end of the reactor can be drawn off immediately, but it is preferably cooled below its glass transition temperature and mechanically comminuted. This can be done e.g. by running the product onto a cooling belt, on which it solidifies, and then comminuting it in a chopper. The coarsely comminuted product can then be further processed immediately or at a later stage by the methods conventionally used in powder coating technology. The resulting polyurethane has a glass transition temperature of −150 to +150° C., but preferably of 35 to 80° C. The viscosity is between 10 and 100,000 Pa-s at 100° C., preferably between 100 and 1000 Pa-s at 100° C. This glass transition temperature and also the viscosity can be adjusted by the appropriate choice of starting materials and their relative initial amounts. The exact process is described in WO 03/04411 1.

The ethylenically unsaturated polyurethanes obtained by the process according to the invention constitute valuable binders for powder coatings. They can be processed as thermally crosslinkable powder varnishes without further additives (in which case the binder would be identical to the coating agent) or, preferably, they can also contain the auxiliary substances and additives conventionally used in coating technology, such as pigments, e.g. titanium dioxide, flow control agents, e.g. polybutyl acrylate or silicones, degassing agents, e.g. benzoin, friction control additives, e.g. aliphatic amines, and/or other additives, and be homogenized e.g. in extruders or kneaders at temperatures of 40 to 140° C., preferably of 70 to 120° C.

The solid obtained is then ground in a manner known per se and the coarse particles, preferably at least those with a size greater than 0.1 mm, are removed by sieving.

The pulverulent coating agents prepared according to the invention can be applied to the substrates to be coated by conventional powder application processes, e.g. electrostatic powder spraying, triboelectric application or fluidized bed coating.

The coatings are then initially melted by the action of heat (e.g. by means of IR radiators, convection or a combination thereof); a clear film forms unless pigments or the like have been incorporated. The temperature during this process is conventionally above 50° C., preferably above 70° C. and particularly preferably above 90° C. The coatings can be cured either by heating to 130 to 220° C., preferably 150 to 190° C., and/or by the action of energy-rich radiation such as UV radiation or an electron beam. As those skilled in the art are aware, an electron beam is produced by means of thermal emission and accelerated through a potential difference. The energy-rich electrons then pass through a titanium foil and are directed onto the binders to be cured. The general principles of electron beam curing are described in detail in “Chemistry & Technology of UV & EB Formulations for Coatings, Inks & Paints”, vol. 1, P. K. T. Oldring (ed.), SITA Technology, London, England, pp 101-157, 1991. Electron beam curing does not require a photoinitiator.

In the case of crosslinking by means of UV radiation, photoinitiators are homogeneously incorporated into the coating materials. Suitable photoinitiators are the compounds in conventional use provided they do not have an adverse effect on the powder properties such as flowability and storability; this can be determined by preliminary experiments. Examples of photoinitiators are 1-hydroxycyclohexyl phenyl ketone, benzil dimethylketal or, for pigmented systems, 2-methyl-1-(4-methylthiophenyl)-2-morpholino-1-propanone or trimethylbenzoyldiphenyl-phosphine oxide.

The photoinitiators, which are used in amounts of between 0.1 and 10 wt. %, preferably of 0.1 to 5 wt. %, based on the weight of the coating binder, can be used as individual substances or, because there are frequently advantageous synergistic effects, they can also be used in combination with one another. Such mixtures of initiators are commercially available (e.g. from Ciba Spezialitätenchemie GmbH).

When thermal curing is used, this can also be carried out with the addition of thermally decomposing free radical generators. As those skilled in the art are aware, suitable examples are peroxy compounds such as tert-butyl perbenzoate, ammonium peroxodisulfate and potassium peroxodisulfate, or azo compounds such as 2,2′-azobis[N-(2-propenyl)-2-methylpropionamide], 1-[(cyano-1-methylethyl)azo]formamide, 2,2′-azobis(N-butyl-2-methylpropionamide), 2,2′-azobis(N-cyclohexyl-2-methylpropionamide), 2,2′-azobis {2-methyl-N-[2-(1-hydroxybutyl)] propionamide} and 2,2′-azobis {2-methyl-N-[1,1-bis(hydroxy-methyl)-2-hydroxy ethyl] propionamide}. Particularly suitable initiators are those in solid form with a melting point below 130° C. and a half-life in the order of minutes at a decomposition temperature above 100° C.

The binders according to the invention for powder coatings are suitable for the coating of substrates made of wood, metal, plastic, glass, textiles or mineral substances, and/or already coated substrates made of said materials, or substrates consisting of any desired combinations of said materials. Applications in the industrial coating of MDF boards or preassembled higher-quality goods already containing temperature-sensitive structural components, e.g. electronic componentry, as well as the coating of furniture, coils, everyday objects, motor vehicle bodywork and associated add-on parts, may be mentioned in particular here.

The urethane acrylates according to the invention can also be used in combination with one another or together with other binders conventionally used in powder coating chemistry, e.g. polyesters, polyacrylates, polyethers, polyamides and polycarbonates, which can also optionally contain unsaturated groups. Suitable unsaturated groups are acrylate, methacrylate, fumarate, maleate, vinyl and/or vinyl ether groups. Acrylate and methacrylate groups are preferred. The proportions are determined so that the double bond density of the resulting mixture does not fall below 1.0 mol of double bonds per kilogram, because adequate curing is otherwise no longer possible. The binders according to the invention can also be used as adhesives and sealing compounds. The condition here in the case of UV radiation curing is that at least one of the two substrates to be bonded or sealed together be permeable to UV radiation, i.e. it must be transparent. If an electron beam is used, it is necessary to ensure an adequate permeability to electrons. Suitable substrates consist of wood, metal, plastic, glass, textiles or mineral substances, and/or are already coated substrates or a mixture of these substrates.

The binders according to the invention are also suitable as curing compounds in moulding, injection moulding and die casting processes. An object to be coated is placed in a mould with a distance of at most 1 cm, preferably of less than 0.3 cm, remaining between the object surface and the mould. The binder according to the invention is then compressed into the mould through an extruder and subsequently cured by the action of heat and/or radiation.

### EXAMPLES

### Example 1

Preparation of a Prepolymer

1344.1 g of isophorone diisocyanate (Desmodur® I, Bayer AG, Leverkusen, DE), 0.50 g of dibutyltin dilaurate (Desmorapid® Z, Bayer AG, Leverkusen, DE), 1.00 g of methyl 4-toluenesulfonate and 1.00 g of 2,6-ditert-butyl-4-methylphenol were weighed out, under a stream of air (3 l per hour), into a 3 l glass flask fitted with a mechanical stirrer, a gas inlet and a thermometer, and the mixture was stirred and heated to 50° C.

653.4 g of 2-hydroxypropyl acrylate (Bisomer® HPA, Interorgana Chemikalienhandel GmbH, Cologne, DE) were then metered in so that the strongly exothermic reaction brought the temperature to 55 to 60° C. This operation took 3 h, the flask being cooled with an ice bath. The mixture was then stirred for 30 min at 60° C. until the NCO content was less than or equal to 14.9% (theory: 14.9%).

| Viscosity: Haake VT 550 rotational viscometer, MV-DIN | 4400 mPa · s |
|---|---|
| cup/23° C./shear gradient 40 s⁻¹ | |
| Isocyanate content [wt. % of NCO]: back titration with | 14.8% |
| HCl against bromophenol blue after addition of excess | |
| butylamine, principle: DIN 53185/10 (theory: 14.9%) | |
| GC against polystyrene standard (Mₙ/M_{w}/D) | 386/433/1.12 |
| Peak areas in % of total | |
| IPDI | 16.0% |
| Monourethane | 69.8% |
| Diurethane | 12.2% |

### Example 2

Continuous Preparation of an Ethylenically Unsaturated Polyurethane

The unsaturated polyurethane was prepared in an experimental plant of the following construction:

two heatable receiver vessels each with a capacity of 50 l, two metering pumps, two flow meters for monitoring the metered streams, two heat exchangers for heating the metered streams, one reaction tube 280 mm in length and 20 mm in diameter, and one connecting reaction tube 1000 mm in length and 40 mm in diameter. The reaction tubes contain appropriate mixing elements and can be heated and cooled with heat transfer fluid.

In such a static mixer unit, a mixture consisting of the prepolymer of Example 1, 1000 ppm of dibutyltin dilaurate from the 1st receiver vessel and 1,2-ethanediol from the 2nd receiver vessel is metered continuously into the static mixer. The reaction product is drawn off continuously at the reactor outlet, cooled and then mechanically comminuted. The following reaction conditions were observed:

| | |
|---|---|
| Metered stream of prepolymer mixture: | 11.595 kg/h |
| Metered stream of ethanediol: | 1.264 kg/h |
| Heat exchanger for prepolymer mixture: | 80° C. |
| Heat exchanger for ethanediol: | 80° C. |
| Reactor inlet temperature for prepolymer mixture and | 80° C. |
| ethanediol: | |
| Reaction path 1: | 130° C. |
| Reaction path 2: | 125° C. |
| Reactor outlet temperature: | 150° C. |

The unsaturated urethane according to the invention obtained under these conditions has the following characteristics: The glass transition temperature was 49.8° C., the complex melt viscosity at 100° C. was 208 Pa·s, the residual NCO content was 0.6% and the content of free hydroxypropyl acrylate was <0.01%.

### Example 3

Comparison: One-Stage Batch Preparation of an Ethylenically Unsaturated Polyurethane of the Same Gross Composition (WO 03/044111, Example 3)

2425.70 g of Desmodur® I [1-isocyanato-3-isocyanatomethyl-3,5,5-trimethyl-cyclohexane (IPDI)] (Bayer AG, Leverkusen, DE) were placed in a flat-flange pot and 1.60 g of 2,5-ditert-butylhydroquinone, 4.00 g of 2,6-ditert-butyl-4-methyl-phenol, 2.00 g of Desmorapide® Z (dibutyltin dilaurate) (Bayer AG, Leverkusen, DE) and 4.00 g of p-methoxyphenol were dissolved therein at 90° C. A mixture of 1179.24 g of hydroxypropyl acrylate and 383.46 g of 1,2-ethanediol was then metered in over 3 h with the evolution of heat, the temperature being kept at 90° C. The temperature was raised to 116° C. as the viscosity of the resin melt increased. After stirring for 1.5 h, the NCO content reached 0.05 wt. %. The melt obtained was transferred to an aluminium dish and left to cool. The glass transition temperature of the amorphous, glass-hard, brittle product was 49.7° C. The complex melt viscosity at 100° C. was 421 Pa·s.

A comparison of the products obtained in Examples 2 and 3 shows that the process according to the invention gives polymers which, for the same gross composition and the same glass transition temperature, have a lower melt viscosity at 100° C.

### Example 4

Comparison: One-Stage Continuous Preparation of an Ethylenically Unsaturated Polyurethane of the Same Gross Composition

In a static mixer unit according to Example 2, a mixture of 60.64 parts by weight of Desmodure® I [1-isocyanato-3-isocyanatomethyl-3,5,5-trimethylcyclohexane (IPDI)], 0.1 part by weight of Desmorapide® Z (dibutyltin dilaurate), 0.04 part by weight of 2,5-ditert-butylhydroquinone, 0.1 part by weight of p-methoxyphenol and 0.1 part by weight of 2,6-ditert-butyl-4-methylphenol was placed in receiver 1 and a mixture of 29.48 parts by weight of 2-hydroxypropyl acrylate and 9.59 parts by weight of 1,2-ethanediol was placed in receiver 2. These mixtures were then metered continuously into the static mixer while observing the following different reaction conditions:

Reaction conditions 4.1)

| | |
|---|---|
| Metered stream for receiver 1: | 3.238 kg/h |
| Metered stream for receiver 2: | 4.970 kg/h |
| Heat exchanger 1: | 80° C. |
| Heat exchanger 2: | 80° C. |
| Reactor inlet temperature: | 80° C. |
| Reaction path 1: | 130° C. |
| Reaction path 2: | 130° C. |
| Reactor outlet temperature: | 142° C. |

The resulting product had a residual NCO content of 1.4%, a glass transition temperature of 42.3° C., a residual content of free IPDI of 0.09% and a content of free 2-hydroxypropyl acrylate of 1.7%. Substantial pressure variations in the reactor could be observed throughout the course of the experiment, making a smooth continuous procedure impossible. The high residual content of free 2-hydroxypropyl acrylate is harmful to man and the environment.

Reaction Conditions 4.2)

The temperatures of the metered streams and reactors were reduced in order to achieve a more uniform procedure without pressure variations.

| | |
|---|---|
| Metered stream for receiver 1: | 3.238 kg/h |
| Metered stream for receiver 2: | 4.970 kg/h |
| Heat exchanger 1: | 70° C. |
| Heat exchanger 2: | 70° C. |
| Reactor inlet temperature: | 70° C. |
| Reaction path 1: | 70° C. |
| Reaction path 2: | 70° C. |
| Reactor outlet temperature: | 152° C. |

The resulting product had a residual NCO content of 1.96%, a glass transition temperature of 39.1° C., a residual content of free IPDI of 0.02% and a content of free 2-hydroxypropyl acrylate of 3.1%. Despite the reduced reaction temperatures, substantial pressure variations in the reactor could be observed throughout the course of the experiment, making a smooth continuous procedure impossible. The high residual content of free 2-hydroxypropyl acrylate is harmful to man and the environment.

Reaction Conditions 4.3)

The amount of Desmorapid® Z (dibutyltin dilaurate) catalyst was doubled to 0.2 part by weight in order to improve the degree of conversion.

| | |
|---|---|
| Metered stream for receiver 1: | 3.238 kg/h |
| Metered stream for receiver 2: | 4.970 kg/h |
| Heat exchanger 1: | 70° C. |
| Heat exchanger 2: | 70° C. |
| Reactor inlet temperature: | 70° C. |
| Reaction path 1: | 70° C. |
| Reaction path 2: | 30° C. |
| Reactor outlet temperature: | 165° C. |

The resulting product had a residual NCO content of 2.2%, a glass transition temperature of 38.6° C., a residual content of free IPDI of 0.04% and a content of free hydroxypropyl acrylate of 2.4%. Substantial pressure variations in the reactor could be observed throughout the course of the experiment, making a smooth continuous procedure impossible. Despite the higher proportion of catalyst, the residual NCO and hydroxypropyl acrylate contents are not reduced.
Reaction Conditions 4.4)

The amount of Desmorapid® Z (dibutyltin dilaurate) catalyst was kept at 0.2 part by weight and the residence time in the reactor was halved by doubling the metered amounts in order to reduce the pressure variations and improve the degrees of conversion.

| | |
|---|---|
| Metered stream for receiver 1: | 6.474 kg/h |
| Metered stream for receiver 2: | 9.940 kg/h |
| Heat exchanger 1: | 70° C. |
| Heat exchanger 2: | 70° C. |
| Reactor inlet temperature: | 70° C. |
| Reaction path 1: | 70° C. |
| Reaction path 2: | 30° C. |
| Reactor outlet temperature: | 188° C. |

The initial product obtained had a residual NCO content of 1.2%, a glass transition temperature of 41.7° C., a residual content of free IPDI of 0.03% and a content of free 2-hydroxypropyl acrylate of 2.6%. After a reaction time of approx. 2 hours, there was a sudden pressure surge and the reactor was then completely blocked due to polymerization.

Conclusion:

An ethylenically unsaturated polyurethane cannot be prepared reproducibly by means of a one-stage continuous process. The products formed have relatively high residual contents of educts, especially 2-hydroxypropyl acrylate, with large variations in process parameters, particularly pressure variations, in the static mixer.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the solventless preparation of ethylenically unsaturated polyurethanes comprising preparing a prepolymer from an isocyanate-containing component A) and an isocyanate-reactive component B) in a batch reaction, and reacting the prepolymer with a further component C) in a second, continuous reaction to give the polyurethane, wherein at least one of the components A, B and C have ethylenically unsaturated groups.

2. The process according to claim 1, wherein the prepolymer has isocyanate groups.

3. The process according to claim 1, wherein the prepolymer has hydroxyl groups.

4. The process according to claim 1, wherein the prepolymer contains ethylenically unsaturated groups.

5. The process according to claim 1, wherein the prepolymer has a viscosity below 10,000 mPa·s at 23° C.

6. The process according to claim 1, wherein the polyurethane has a viscosity of 10 to 100,000 Pa·s at 100° C.

7. The process according to claim 1, wherein the polyurethane has a viscosity of 100 to 1000 Pa·s at 100° C.

8. The process according to claim 1, wherein the polyurethane has a glass transition temperature of between 40 and 150° C.

9. The process according to claim 1, wherein the polyurethane has a glass transition temperature of between 35 and 80° C.

10. The process according to claim 1, wherein the continuous reaction is carried out in a static mixer.

11. The process according to claim 1, wherein the continuous reaction is carried out at temperatures of 50 to 300° C.

12. The process according to claim 1, wherein the reactants in the continuous reaction have residence times in the reaction zone of between 20 s and 30 min.

13. The process according to claim 2, wherein the prepolymer contains ethylenically unsaturated groups.

14. The process according to claim 3, wherein the prepolymer contains ethylenically unsaturated groups.

15. The process according to claim 2, wherein the prepolymer has a viscosity below 10,000 mPa·s at 23° C.

16. The process according to claim 3, wherein the prepolymer has a viscosity below 10,000 mPa·s at 23° C.

17. The process according to claim 4, wherein the prepolymer has a viscosity below 10,000 mPa·s at 23° C.
